(19) United States
(12) Patent Application Publication
(10) Pub. No.: US 2025/0148928 A1
(43) Pub. Date: May 8, 2025

(54) APPARATUS, METHOD AND SYSTEM

(71) Applicant: Cookpad Inc., Tokyo (JP)

(72) Inventor: Akimitsu SANO, Tokyo (JP)

(73) Assignee: Cookpad Inc., Tokyo (JP)

(21) Appl. No.: 19/002,714

(22) Filed: Dec. 27, 2024

Related U.S. Application Data
(63) Continuation of application No. PCT/JP2024/015101, filed on Apr. 16, 2024.

(30) Foreign Application Priority Data
Feb. 24, 2023 (JP) 2023-027329

(51) Int. Cl. G09B 7/00

(52) U.S. Cl. CPC G09B 7/00

(57) ABSTRACT

An apparatus according to an aspect of the present disclosure comprising: processing circuitry configured to: store a dish, a failure type of the dish, and knowledge about the failure type of the dish in association with each other; identify a target dish of interest to a user; select at least one failure type of the failure type associated with the target dish; and output the knowledge associated with the selected failure type.

### CROSS-REFERENCE TO RELATED APPLICATIONS

This application is a continuation of International Application No. PCT/JP2024/015101, filed Apr. 16, 2024, which claims priority to Japanese Patent Application No.2023-027329, filed Feb. 24, 2023, the entire contents of each are incorporated herein by reference.

### FIELD

The present disclosure relates to an information processing apparatus, a method, a program, and a system.

### BACKGROUND

When making a dish with reference to an existing recipe, the cook may forget, misunderstand or ignore details of the recipe and fail to cook the dish.

There is disclosed a conventional technical idea of adding image information representing auxiliary information about cooking to an image of an entity in the user's field of view during the execution of cooking, with the aim of enabling the user to obtain auxiliary information about cooking in real time during the execution of cooking.

Cooks vary from person to person, for example, in skills, knowledge, preferences, personality, or habits of thought or action. Thus, information of value to the cook may vary. For example, let us assume that there is an important requirement (e.g., action) to make a particular dish well. In this case, a situation may arise in which users who are good at this dish clear the above requirement without being particularly conscious of it, while other users may not be able to cook the dish well because they do not know or disregard the importance of this requirement. If appropriate knowledge can be provided to users who do not know or disregard the importance of such a requirement, such users may be able to make this dish without failure.

An object of the present disclosure is to provide a technique for providing cooking instruction suitable for users.

### BRIEF DESCRIPTION OF THE DRAWINGS

FIG. 1 is a block diagram showing a configuration of an information processing system of the present embodiment.

FIG. 2 is a block diagram showing a configuration of a client apparatus of the present embodiment.

FIG. 3 is a block diagram showing a configuration of a server of the present embodiment.

FIG. 4 is an explanatory diagram of an aspect of the present embodiment.

FIG. 5 shows a data structure of a knowledge database of the present embodiment.

FIG. 6 shows a data structure of a user database of the present embodiment.

FIG. 7 shows a data structure of a review database of the present embodiment.

FIG. 8 shows an overall flow of information processing of the present embodiment.

FIG. 9 shows a screen example displayed in the information processing of the present embodiment.

FIG. 10 shows a data structure of a knowledge database of a first modification.

FIG. 11 shows an overall flow of information processing of the first modification.

### DETAILED DESCRIPTION

In general, according to one embodiment, an apparatus according to an aspect of the present disclosure comprises: processing circuitry configured to: store a dish, a failure type of the dish, and knowledge about the failure type of the dish in association with each other; identify a target dish of interest to a user; select at least one failure type of the failure type associated with the target dish; and output the knowledge associated with the selected failure type.

Hereinafter, an embodiment of the present invention will be described with reference to the drawings. In the drawings illustrating the embodiment, the same constituent elements are denoted by the same reference numeral in principle, and repeated descriptions thereof will be omitted.

### (1) Configuration of Information Processing System

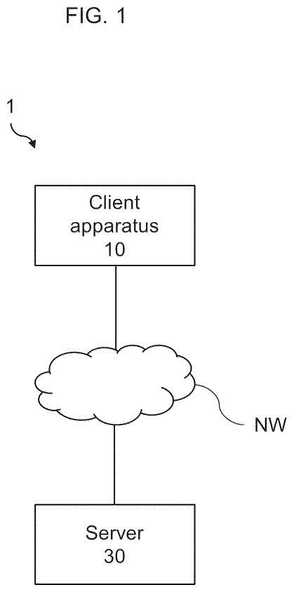

A configuration of an information processing system will be described. FIG. 1 is a block diagram showing a configuration of an information processing system of the present embodiment.

As shown in FIG. 1, an information processing system 1 includes a client apparatus 10 and a server 30.

The client apparatus 10 and the server 30 are connected via a network (e.g., Internet or intranet) NW.

The client apparatus 10 is an example of an information processing apparatus that transmits a request to the server 30. The client apparatus 10 is, for example, a smartphone, a tablet terminal, or a personal computer. The user of the client apparatus 10 is, for example, a person who cooks. The user may post a recipe, or submit a review of a recipe or dish, to the information processing system 1. The user may also receive a recipe, a review posted with respect to the recipe, or knowledge about cooking from the information processing system 1.

The server 30 is an example of the information processing apparatus that provides the client apparatus 10 with a response in response to a request transmitted from the client apparatus 10. The server 30 is, for example, a server computer.

### (1-1) Configuration of Client Apparatus

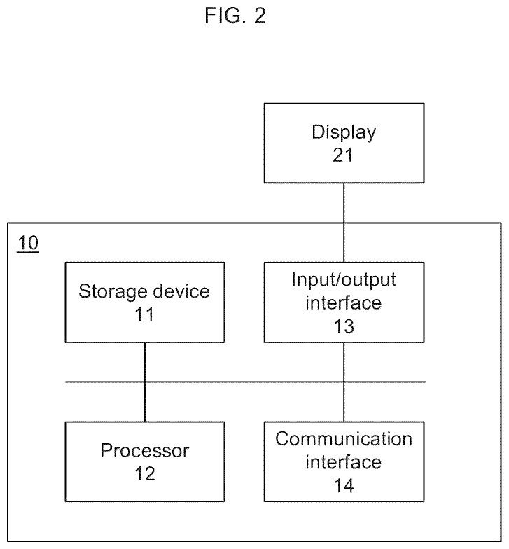

The configuration of the client apparatus will be described. FIG. 2 is a block diagram showing a configuration of the client apparatus of the present embodiment.

As shown in FIG. 2, the client apparatus 10 includes a storage device 11, a processor 12, an input/output interface 13, and a communication interface 14. The client apparatus 10 is connected to a display 21.

The storage device 11 is configured to store programs and data. The storage device 11 is, for example, a combination of a read only memory (ROM), a random access memory (RAM), and a storage (such as a flash memory or a hard disk).

The programs include, for example, the following programs:
Operating system (OS) program; and
Program of an application (such as a web browser) that executes information processing.

The data includes, for example, the following data:
Database referred to in information processing; and
Data obtained by executing information processing (i.e., results of executing information processing).

The processor 12 is a computer that implements the functions of the client apparatus 10 by activating programs stored in the storage device 11. The processor 12 is, for example, at least one of the following:
Central processing unit (CPU);
Graphic processing unit (GPU);
Application specific integrated circuit (ASIC); and
Field programmable array (FPGA).

The input/output interface 13 is configured to acquire information (such as a user instruction, an image, or a sound) from an input device connected to the client apparatus 10 and output information (such as an image or a sound) to an output device connected to the client apparatus 10.

The input device is, for example, a keyboard, a pointing device, a touch panel, a camera, a microphone, a sensor, or a combination thereof.

The output device is, for example, a display 21, a speaker (which may include a smart speaker), or a combination thereof.

The communication interface 14 is configured to control communication between the client apparatus 10 and external apparatuses (which may include, for example, cooking utensils, cooking equipment, or other kitchen appliances (not shown), as well as the server 30).

The display 21 is configured to display an image (still image or moving image). The display 21 is, for example, a liquid crystal display or an organic EL display.

### (1-2) Configuration of Server

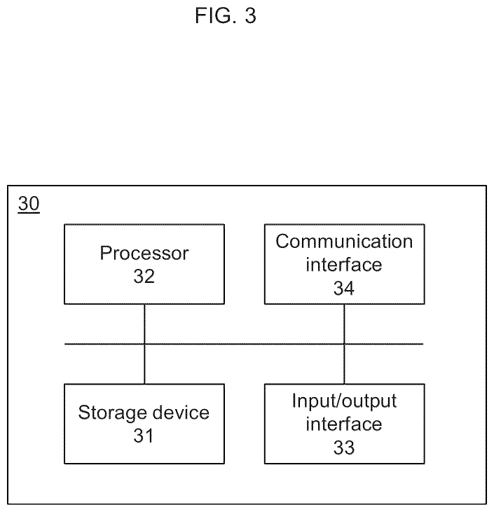

A configuration of the server will be described. FIG. 3 is a block diagram showing a configuration of the server of the present embodiment.

As shown in FIG. 3, the server 30 includes a storage device 31, a processor 32, an input/output interface 33, and a communication interface 34.

The storage device 31 is configured to store programs and data. The storage device 31 is, for example, a combination of a ROM, a RAM, and a storage (such as a flash memory or a hard disk).

The programs include, for example, the following programs:
OS program; and
Program of an application that executes information processing.

The data includes, for example, the following data:
Database referred to in information processing; and
Results of executing information processing.

The processor 32 is a computer that implements the functions of the server 30 by activating programs stored in the storage device 31. The processor 32 is, for example, at least one of the following:
CPU;
GPU;
ASIC; and
FPGA.

The input/output interface 33 is configured to acquire information (such as a user instruction) from an input device connected to the server 30 and output information (such as an image) to an output device connected to the server 30.

The input device is, for example, a keyboard, a pointing device, a touch panel, or a combination thereof.

The output device is, for example, a display.

The communication interface 34 is configured to control communication between the server 30 and external apparatuses (such as the client apparatus 10).

### (2) Aspect of Embodiment

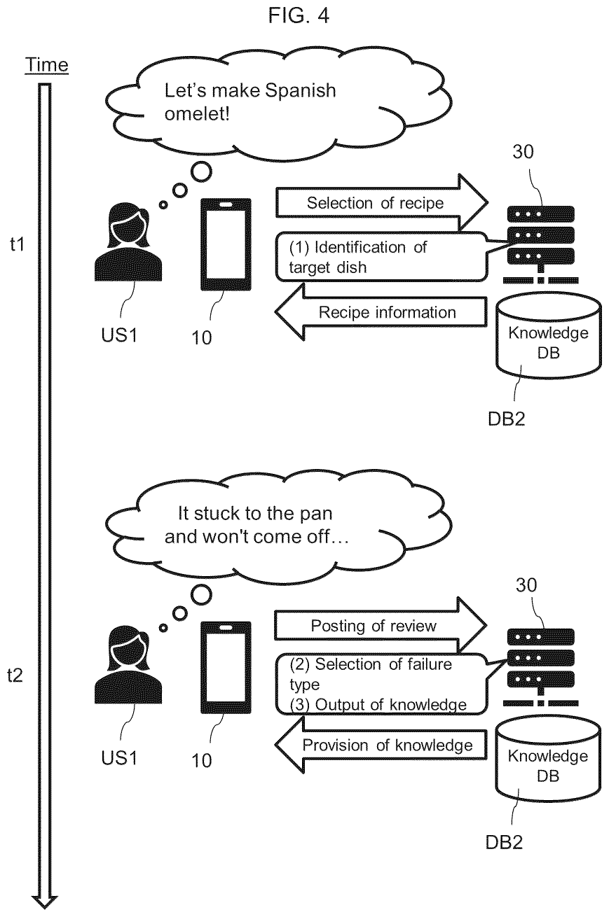

First, an aspect of the present embodiment will be described. FIG. 4 is an explanatory diagram of an aspect of the present embodiment.

As shown in FIG. 4, a user US1 intends to make a Spanish omelet at time t1, and requests the server 30 to search for recipe information by operating the client apparatus 10. The server 30 returns a search result as a response. When the user US1 selects a favorite recipe, the client apparatus 10 transmits information that can identify the selected recipe to the server 30. The server 30 identifies a dish (an example of the “target dish”) the user intends to make, and transmits recipe information to the client apparatus 10. Then, the user US1 starts cooking a Spanish omelet in accordance with the selected recipe.

Let us assume that, after that, the user US1 experiences at time t2 that ingredients stick to the surface of the frying pan during the process of frying the ingredients, causing the finished product to lose its shape. The user US1 operates the client apparatus 10 to post a review of the selected recipe to the server 30 during or after cooking. The server 30 can access a knowledge database to be described later. In a knowledge database DB2, a dish, a failure type of the dish, and knowledge related to the failure type of the dish are associated with each other. The server 30 selects one of the failure types associated with the identified target dish, “Spanish omelet”, that best fits the review of the user US1 (for example, “ingredients stick to the surface of the pan and lose the shape”). Then, the server 30 outputs the knowledge (e.g., a message (which may include a voice) “It is important to heat the frying pan thoroughly before oiling it.”, or an explanatory image (which may include a moving image), or the like) associated with the selected failure type. The client apparatus 10 presents the output knowledge to the user US1. If the user US1 can understand, for example, that their oiling timing is too early based on the presented knowledge, the user US1 is encouraged to be conscious of the oiling timing when cooking the same or a similar dish next time, so that the user US1 is less likely to repeat the same failure. On the other hand, if another user experiences a failure such as uneven cooking of ingredients of a Spanish omelet, knowledge that, for example, it is important to cut vegetables in small and uniform shapes, and the user will be more careful in the vegetable cutting process. As described above, according to the information processing system 1 of the present embodiment, a cooking instruction suitable for the user can be provided.

### (3) Databases

The databases of the present embodiment will be described. The following databases are stored in the storage device 31.

### (3-1) Knowledge Database

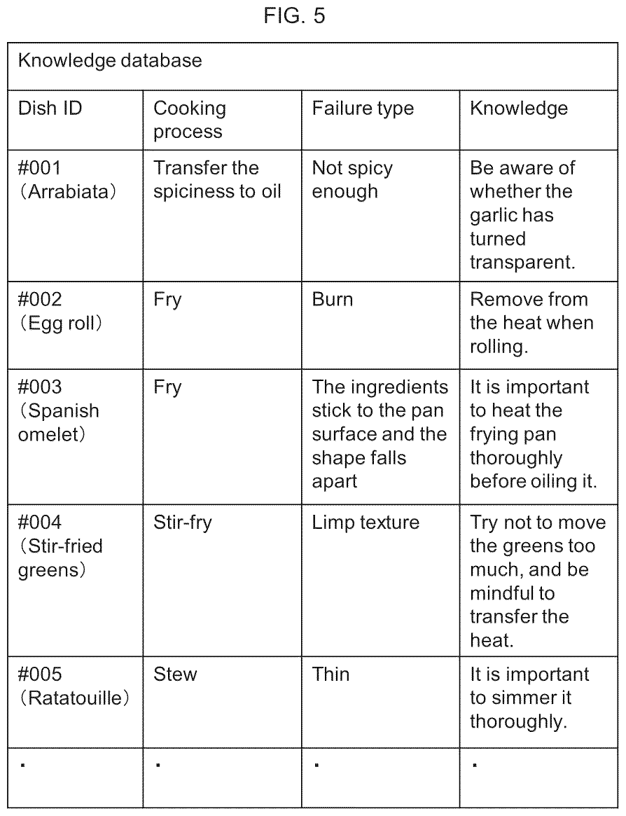

A knowledge database of the present embodiment will be described. FIG. 5 shows a data structure of the knowledge database of the present embodiment.

First knowledge information is stored in the knowledge database. The first knowledge information is information on knowledge about a failure type of a dish.

As shown in FIG. 5, the knowledge database includes a “dish ID” field, a “cooking process” field, a “failure type” field, and a “knowledge” field. The fields are associated with each other.

A dish ID is stored in the “dish ID” field. The dish ID is information for uniquely identifying a dish. Note that a recipe ID may be used instead of the dish ID. The recipe ID is information for uniquely identifying a recipe. For example, each dish may have one or more recipes for making the dish, and each recipe may be provided with a recipe ID for identifying the recipe and a dish ID for identifying the dish corresponding to the recipe. Dishes can also be grouped in multiple layers based on the genre, ingredients, or cooking process. That is, Spanish omelet is a sub-concept of omelet and omelet is a sub-concept of egg dish, but Spanish omelet, omelet, and egg dish may each be defined as a dish.

Cooking process information is stored in the “cooking process” field. The cooking process information is information on the process of cooking the dish identified by the corresponding dish ID. The cooking process information may be defined for each dish or recipe, or may be defined commonly among dishes or recipes.

Failure type information is stored in the “failure type” field. The failure type information is information on the failure type of the dish identified by the corresponding dish ID (or a combination of the dish ID and the cooking process information). The failure type information may be created based on the knowledge of a skilled person such as a cooking instructor or may be created by analyzing user's reviews of a particular recipe and extracting frequent failures for the dish to which the recipe belongs.

Knowledge detail information is stored in the “knowledge” filed. The knowledge detail information is information on the details of the knowledge relating to the corresponding failure type. The knowledge detail information is, for example, information on points be aware of (e.g., do not move ingredients carelessly during heating) and tasks to be performed (e.g., carefully wipe off water from ingredients) in order to prevent the corresponding failure type. The knowledge detail information may include text, an image (a photo or a moving image), a voice, or a combination thereof constituting the knowledge, or information on the location (address) thereof. The knowledge detail information may be created based on the knowledge of a skilled person such as a cooking instructor.

### (3-2) User Database

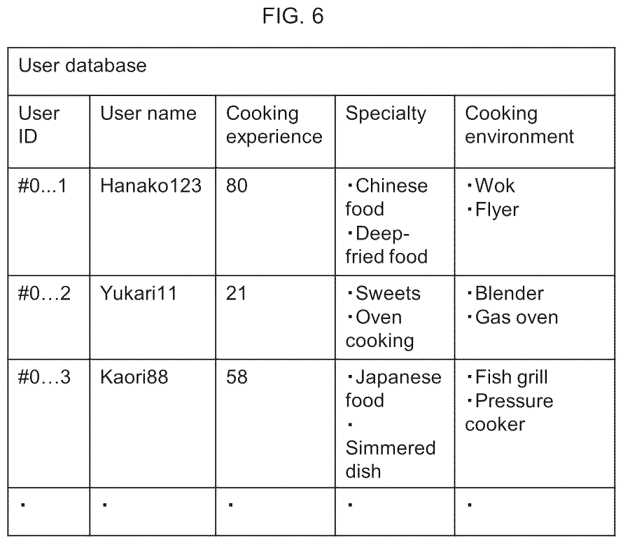

A user database of the present embodiment will be described. FIG. 6 shows a data structure of the user database of the present embodiment.

User information is stored in the user database. The user information is information on a user of the information processing system 1.

As shown in FIG. 6, the user database includes a “user ID” field, a “user name” field, a “cooking experience” field, a “specialty” field, and a “cooking environment” field. The fields are associated with each other.

A user ID is stored in the “user ID” field. The user ID is information for uniquely identifying a user of the information processing system 1.

User name information is stored in the “user name” field. The user name information is information on the name of the user identified by the user ID.

Cooking experience information is stored in the “cooking experience” field. The cooking experience information is information on the cooking experience of the user identified by the user ID, and is an example of the attribute information of the user. As an example, the cooking experience information is a score that quantifies the cooking experience of the user. The cooking experience may be calculated, for example, based on the reported number of recipes used or postings by the user, or the cumulative number of review postings, or the result of analyzing the recipes or reviews posted by the user, or may be set based on the user's self-report. Cooking experience may also be defined by category corresponding to, for example, the genre, ingredients, cooking process, or a combination thereof.

Specialty information is stored in the “specialty” field. The specialty information is information on the specialty of the user identified by the user ID, and is an example of the attribute information of the user. The specialty may be, for example, a specialty genre, ingredients, or cooking process. The specialty information may be determined based on the reported number of recipes used or postings by the user, or the cumulative number of review postings, or the result of analyzing the recipes or reviews posted by the user, or may be set based on the user's self-report. Note that, although not shown, it is also possible to define and utilize information on the weak area (weak area information) in the same manner.

Cooking environment information is stored in the “cooking environment” field. The cooking environment information is information on the cooking environment of the user identified by the user ID, and is an example of the attribute information of the user. The cooking environment may include, for example, the type, number, or specifications of cooking utensils, cooking equipment, or other kitchen appliances available to the user. The cooking environment information may be set based on the user's self-report or on the presence or absence of linkage to the client apparatus 10.

### (3-3) Review Database

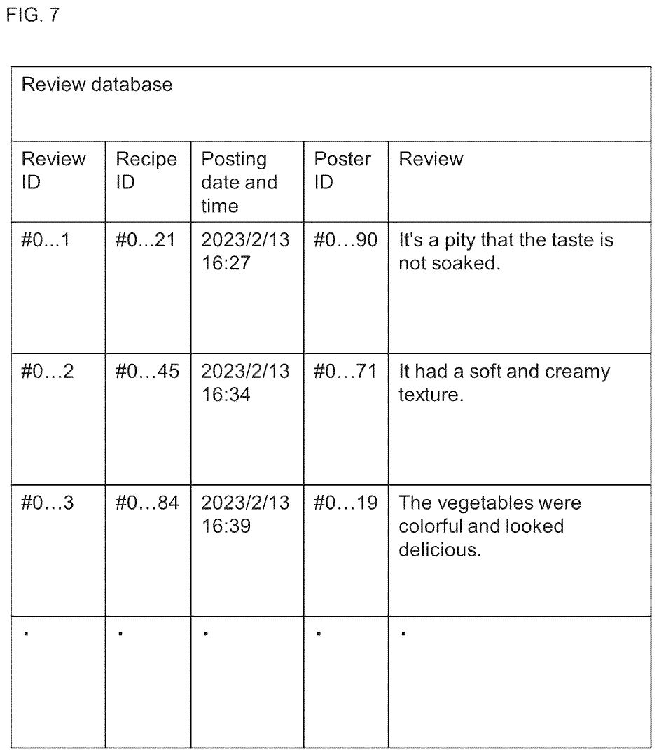

A review database of the present embodiment will be described. FIG. 7 shows a data structure of the review database of the present embodiment.

Review information is stored in the review database. The review information is information on a user's review of a recipe provided by the information processing system 1. A group of reviews posted by the same user is an example of the cooking history of the user.

As shown in FIG. 7, the review database includes a “review ID” field, a “recipe ID” field, a “posting date and time” field, a “poster ID” field, and a “review” field. The fields are associated with each other.

A review ID is stored in the “review ID” field. The review ID is information for uniquely identifying a review.

A recipe ID is stored in the “recipe ID” field. The recipe ID is information for uniquely identifying the recipe that is the subject of the review identified by the review ID.

Posting date and time information is stored in the “posting date and time” field. The posting date and time information is information on the date and time when the review identified by the review ID was posted.

A poster ID is stored in the “poster ID” field. The poster ID uniquely identifies the poster (user) of the review identified by the review ID. That is, the user ID in the user database (FIG. 6) can be used as the poster ID.

Review detail information is stored in the “review” field. The review detail information is information on the details of the review identified by the review ID. The review detail information may include text, an image (a photo or a moving image), a voice, or a combination thereof constituting the review, or information on the location (address) thereof.

### (3-4) Other Databases

In addition to the above, a recipe database can be stored in the storage device 31. Recipe information is stored in the recipe database. The recipe information may include, in association with the recipe ID, information indicating the user who posted the corresponding recipe (recipe poster) and the posting date and time, information indicating the details of the recipe, and a dish ID indicating the dish corresponding to the recipe. A group of recipes posted by the same user is an example of the cooking history of the user.

### (4) Information Processing

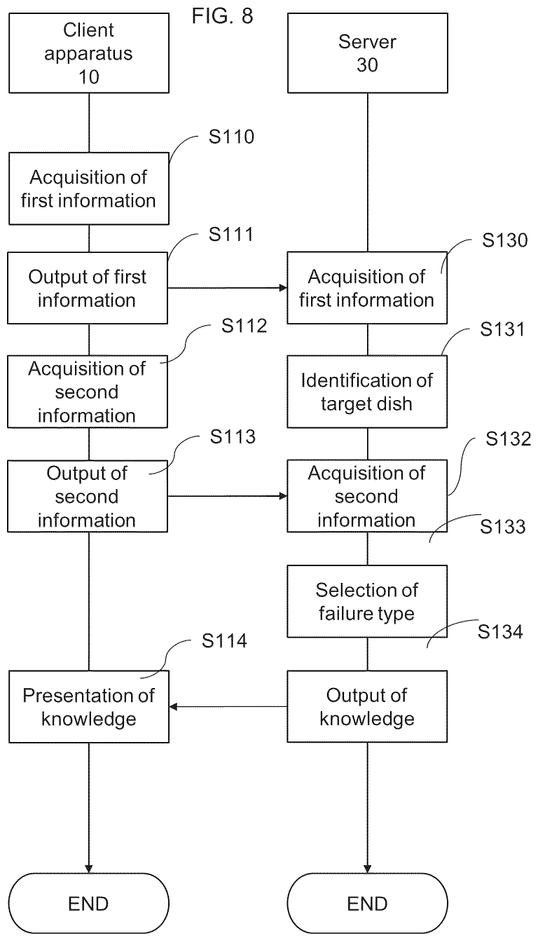

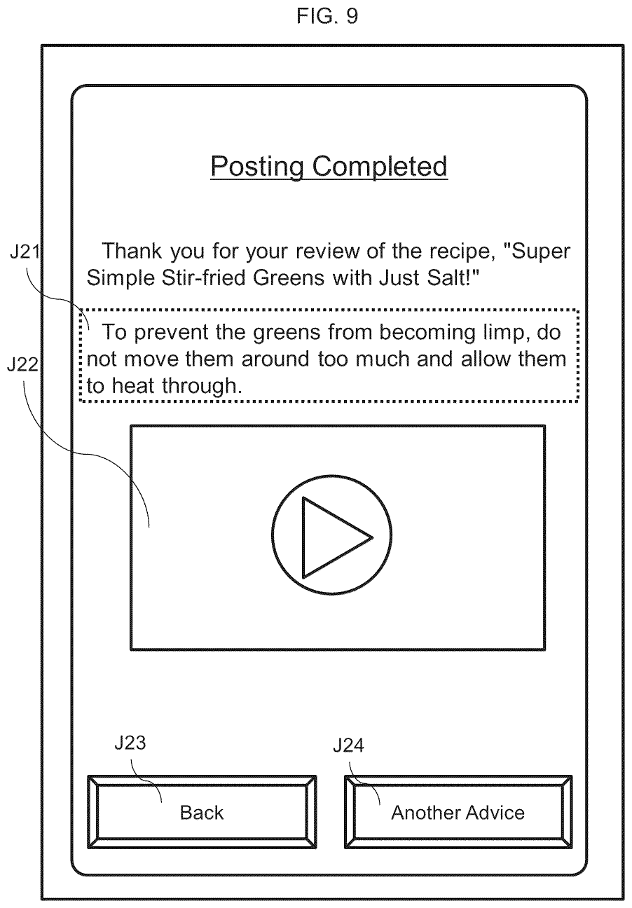

Information processing of the present embodiment will be described. FIG. 8 shows an overall flow of the information processing of the present embodiment. FIG. 9 shows a screen example displayed in the information processing of the present embodiment.

As shown in FIG. 8, the client apparatus 10 executes acquisition of first information (S110).

Specifically, the client apparatus 10 acquires information (hereinafter referred to as “first information”) on a dish of interest to the user (hereinafter referred to as a “target dish”).

The target dish may be at least one of the following:
Dish the user has made;
Dish the user has eaten;
Dish being made by the user;
Dish being eaten by the user;
Dish or candidate dish the user is about to make; and
Dish or candidate dish the user is about to eat.

As a first example of the acquisition of the first information (S110), the client apparatus 10 receives, from the user, an instruction to select one of the recipes provided by the information processing system 1.

As a second example of the acquisition of the first information (S110), the client apparatus 10 receives, from the user, an instruction for causing a cooking utensil (cooking appliance), cooking equipment, or other kitchen appliances to execute one of the cooking menus.

As a third example of the acquisition of the first information (S110), the client apparatus 10 receives information (e.g., an execution history) on the execution of one of the cooking menus from a cooking utensil (cooking appliance), cooking equipment, or other kitchen appliances.

As a fourth example of the acquisition of the first information (S110), the client apparatus 10 acquires, from a camera, an image of the user during cooking or an image of a dish being made or completed.

As a fifth example of the acquisition of the first information (S110), the client apparatus 10 acquires, from a microphone, the user's speech or a sound produced by the user's cooking activity.

The sixth example of the acquisition of the first information (S110) is a combination of two or more of the above first to fifth examples.

After step S110, the client apparatus 10 executes output of the first information (step S111).

Specifically, the client apparatus 10 transmits the first information acquired in step S110 to the server 30.

After step S111, the server 30 executes the acquisition of the first information (S130).

Specifically, the server 30 receives the first information transmitted in step S111.

After step S130, the server 30 executes identification of the target dish (S131).

Specifically, the server 30 identifies the target dish based on the first information acquired in step S130.

As a first example of the identification of the target dish (S131), the server 30 identifies a dish corresponding to the recipe selected by the user as the target dish.

As a second example of the identification of the target dish (S131), the server 30 identifies, as the target dish, a dish corresponding to a cooking menu executed by a cooking utensil (cooking appliance), cooking equipment, or other kitchen appliances.

As a third example of the identification of the target dish (S131), the server 30 analyzes the feature of the image or sound and identifies a dish for which a similar feature can be observed as the target dish. For example, a model that has learned correlations between images or sounds and dishes can be used to identify the target dish.

The fourth example of the identification of the target dish (S131) is a combination of two or more of the above first to third examples.

On the other hand, after step S111, the client apparatus 10 executes acquisition of second information (S112).

Specifically, the client apparatus 10 acquires information (hereinafter referred to as “second information”) on one of the following elements, which implicitly or explicitly indicates a failure of the target dish:
Dish made by the user;
Dish eaten by the user;
Dish being made by the user;
User during cooking; and
Dish being eaten by the user.

As a first example of the acquisition of the second information (S112), the client apparatus 10 presents information on one or more failure types associated with the target dish (which may include “not applicable”) by means of the display 21 or a speaker, and asks the user which type most closely matches their impression of the dish being made or being eaten by the user, or the dish made or eaten by the user. Then, the client apparatus 10 receives a user instruction for designating one type. The information on the failure type associated with the target dish may be transmitted from the server 30 to the client apparatus 10 after step S131 and before step S112.

As a second example of the acquisition of the second information (S112), the client apparatus 10 acquires, in response to an input from the user, the user's review of a dish the user has made or a dish the user has eaten.

As a third example of the acquisition of the second information (S112), the client apparatus 10 acquires an image of a dish or a user captured while the user is cooking or eating.

As a fourth example of the acquisition of the second information (S112), the client apparatus 10 acquires a sound (sound signal) received by a microphone while the user is cooking or eating.

The fifth example of the acquisition of the second information (S112) is a combination of two or more of the above first to fourth examples. Note that the acquisition of the second information (S112) may be triggered by detection of a particular speech or gesture by the user.

After step S112, the client apparatus 10 executes output of the second information (S113).

Specifically, the client apparatus 10 transmits the second information acquired in step S112 to the server 30.

After step S113, the server 30 executes the acquisition of the second information (S132).

Specifically, the server 30 receives the second information transmitted in step S113. Further, the server 30 may extract user information (in particular, attribute information) stored in the user database (FIG. 6) as the second information, may extract review information (review information posted by the same user in the past) stored in the review database (FIG. 7) as the second information, or may extract recipe information (recipe information posted by the same user in the past) stored in the recipe database (not shown) as the second information.

After step S132, the server 30 executes selection of a failure type (S133).

Specifically, the server 30 refers to the knowledge database (FIG. 5) and selects at least one of the failure types associated with the target dish identified in step S131 based on the second information acquired in step S132.

As a first example of the selection of a failure type (S133), the server 30 selects a failure type designated by the user.

As a second example of the selection of a failure type (S133), the server 30 selects a failure type based on the result of analyzing the user's review of the dish made by the user or the dish eaten by the user. As an example, the server 30 may select a failure type that best matches the user's review with respect to meaning or expression. Note that the analysis of the review may be performed by the server 30, the client apparatus 10, or an external apparatus.

As a third example of the selection of a failure type (S133), the server 30 selects a failure type based on the result of analyzing an image or sound collected while the user is cooking or eating. For example, the image reflects the shape or color of the food, or the behavior of the user (e.g., the time it takes to perform a particular cooking process, or the magnitude of movement). In addition, the sound reflects a sound made by ingredients during the cooking process (e.g., a sound made when ingredients are heated), the hardness, moisture content, or the like of the food. As an example, the server 30 may select a failure type with a high possibility that a similar feature is observed, by applying a trained model that infers a failure type to the feature based on the image or sound. Such a model can be constructed by supervised learning using training data including a large number of sample features (image or sound features collected during cooking or eating of a particular dish) and correct data (results of judgment of the failure type of the dish by a human (e.g., a person or a third person)). Note that the analysis of the image or sound (e.g., extraction of a feature) may be performed by the server 30, the client apparatus 10, or an external apparatus.

As a fourth example of the selection of a failure type (S133), the server 30 selects a failure type based on user information or a group of reviews or recipes posted by the user. For example, even in the case of the same dish, the points at which the dish is likely to fail may differ between a user with limited experience in cooking similar dishes and a user with moderate experience in cooking similar dishes. As an example, the server 30 applies a trained model that infers a failure type to a feature based on these types of information, thereby selecting a failure type that a cook with a similar feature observed is likely to fall into. Such a model can be constructed by supervised learning using training data including a large number of sample features (features of attributes or cooking histories of cooks who made a particular dish) and correct data (results of judgment of the failure type of the dish by a human (e.g., the person themselves or a third person)). The extraction of the feature may be performed by the server 30, the client apparatus 10, or an external apparatus.

As a fifth example of the selection of a failure type (S133), the server 30 determines a cooking process when the user uttered a particular keyword or performed a particular gesture, for example, based on the result of analyzing an image or sound collected while the user was cooking, and selects a failure type associated with the target dish and cooking process information corresponding to the determined cooking process.

After step S133, the server 30 executes output of knowledge (step S134).

Specifically, the server 30 refers to the knowledge database (FIG. 5) and acquires the knowledge associated with the failure type selected in step S133. The server 30 transmits the acquired knowledge to the client apparatus 10.

After step S134, the client apparatus 10 executes presentation of the knowledge (S114).

Specifically, the client apparatus 10 receives the knowledge transmitted in step S134, and presents it to the user. For example, the client apparatus 10 displays the knowledge (text or image) on the display 21 or outputs the knowledge (voice) from a speaker. Alternatively, the client apparatus 10 may provide recipe information to which the knowledge has been added to the user. FIG. 9 shows an example of the screen displayed on the display 21.

The screen of FIG. 9 includes objects J21 to J24.

The object J21 displays text corresponding to knowledge.

The object J22 receives a user instruction for starting reproduction of a moving image corresponding to knowledge, and displays the moving image after receiving the user instruction.

The object J23 receives a user instruction for returning to the previous screen.

The object J24 receives a user instruction for requesting the provision of another piece of knowledge. The client apparatus 10 transmits information indicating that the object J24 has been selected to the server 30. In response to the acquisition of such information, the server 30 may re-execute the selection of a failure type (S133), in which case the previously selected failure type may be excluded from the candidates.

### (5) Summary

As described above, the server 30 of the present embodiment stores a dish, the failure type of the dish, and the knowledge related to the failure type of the dish in association with each other. The server 30 identifies a target dish of interest to the user, selects at least one failure type associated with the target dish, and outputs knowledge associated with the selected failure type. Accordingly, the user is encouraged to perform a more suitable cooking action the next time the user cooks the same or a similar dish based on the presented knowledge, so that the same failure is less likely to be repeated. As described above, cooking instruction suitable for the user can be provided.

The server 30 may select at least one failure type associated with the target dish in accordance with an instruction by the user. This makes it possible to provide knowledge corresponding to the failure that the user is aware of.

The server 30 may acquire a user's review of a dish made by the user or a dish eaten by the user, and select at least one failure type associated with the target dish based on the result of analyzing the review. This makes it possible to provide knowledge corresponding to the failure type estimated from the user's review.

The server 30 may select at least one failure type associated with the target dish based on at least one of the attribute of the user and the cooking history of the user. This makes it possible to narrow down the failure types that the user is likely to fall into based on the attribute or cooking history of the user and provide knowledge that is likely to be valuable to the user.

The server 30 may acquire at least one of the image and sound collected during cooking or eating of the target dish and select at least one failure type associated with the target dish based on the result of analyzing the acquired image or sound. This makes it possible to provide knowledge that is highly likely to be valuable to the user while reducing the time and effort of user's input operation.

### (6) Modifications

Modifications of the present embodiment will be described.

### (6-1) First Modification

A first modification of the present embodiment will be described. The first modification provides knowledge different from that in the first embodiment.

The configuration of the information processing system of the first modification may be the same as that of the present embodiment.

### (6-1-1) Databases

The databases of the first modification will be described. The following databases are stored in the storage device 31.

### (6-1-1-1) Knowledge Database

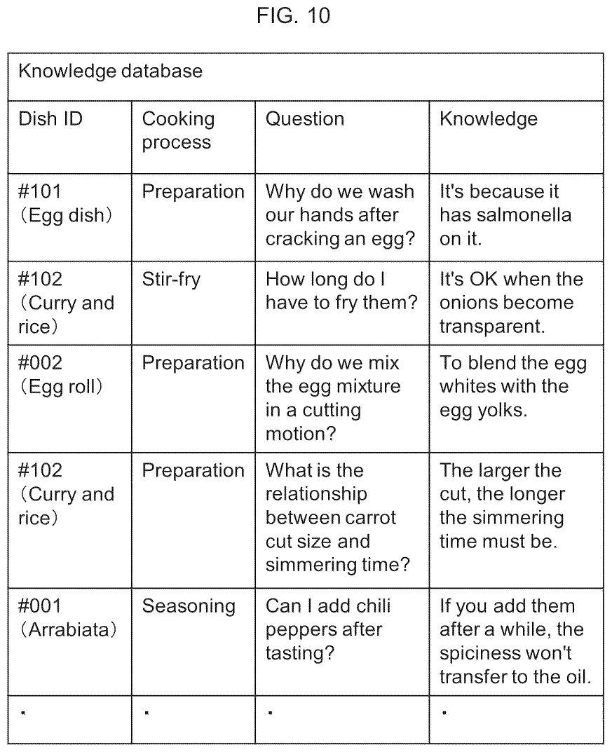

The knowledge database of the first modification will be described. FIG. 10 shows a data structure of the knowledge database of the first modification.

Second knowledge information is stored in the knowledge database. The second knowledge information is information on knowledge on resolution of a questions about a dish, a genre, an ingredient, or a cooking process, background knowledge thereof, or details or arrangement elements thereof.

As shown in FIG. 10, the knowledge database includes a “dish ID” field, a “cooking process” field, a “question” field, and a “knowledge” field. The fields are associated with each other.

A dish ID is stored in the “dish ID” field. The dish ID is the same as that in the knowledge database (FIG. 5) of the present embodiment.

Cooking process information is stored in the “cooking process” field. The cooking process information is the same as that in the knowledge database (FIG. 5) of the embodiment.

Question information is stored in the “question” field. The question information is information on a question about the dish identified by the corresponding dish ID (or a combination of the dish ID and the cooking process information). The question information may be created based on the knowledge of a skilled person such as a cooking instructor or may be created by analyzing user's reviews or questions from users regarding a particular recipe and extracting frequent questions for the dish to which the recipe belongs. Alternatively, the question information may be created by asking quizzes about a dish to a large number of users or a large number of persons other than users and analyzing the answer results to extract questions for which a large number of users or persons do not know the correct answers.

Knowledge detail information is stored in the “knowledge” filed. The knowledge detail information is information on the details of the knowledge about the corresponding question. The knowledge detailed information is, for example, information on the answer to the corresponding question (for example, the significance of the cooking process or its details, an indication of the progress of the cooking process, whether the ingredients or the cooking process can be changed, or the like). The knowledge detail information may include text, an image (a photo or a moving image), a voice, or a combination thereof constituting the knowledge, or information on the location (address) thereof. The knowledge detail information may be created based on the knowledge of a skilled person such as a cooking instructor.

### (6-1-2) Information Processing

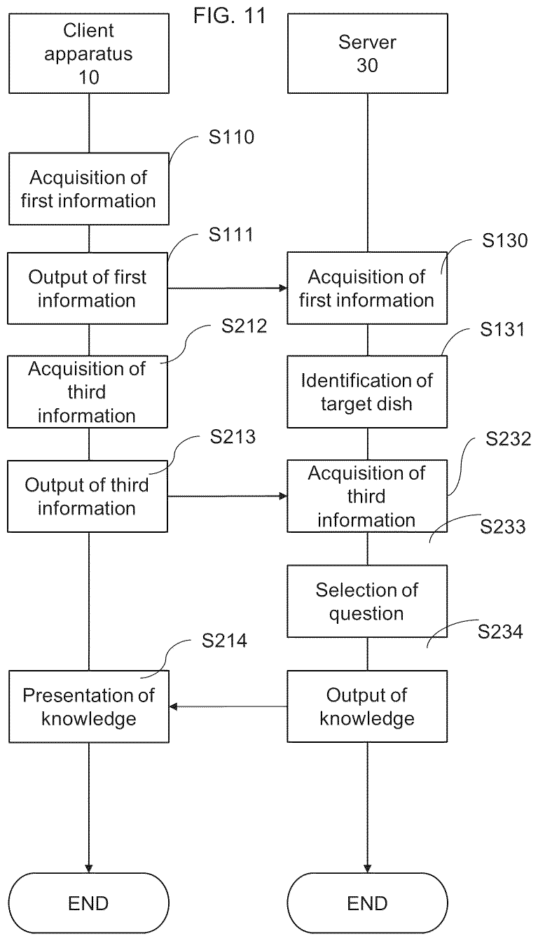

Information processing of the first modification will be described. FIG. 11 shows an overall flow of the information processing of the first modification.

As shown in FIG. 11, the client apparatus 10 executes the acquisition of the first information (S110) and the output of the first information (S111) as in FIG. 8.

After step S111, the server 30 executes the acquisition of the first information (S130) and the identification of the target dish (S131) as in FIG. 8.

On the other hand, after step S111, the client apparatus 10 executes acquisition of third information (S212).

Specifically, the client apparatus 10 acquires information (hereinafter referred to as “third information”) on one of the following elements, which implicitly or explicitly indicates a question about the target dish:
Dish made by the user;
Dish eaten by the user;
Dish being made by the user;
User during cooking; and
Dish being eaten by the user.

As a first example of the acquisition of the third information (S212), the client apparatus 10 presents information on one or more questions associated with the target dish (which may include “not applicable”) by means of the display 21 or a speaker, and asks the user which question most closely matches the question about the dish being made or being eaten by the user, or the dish made or eaten by the user. Then, the client apparatus 10 receives a user instruction for designating one type. Note that the information on the question associated with the target dish may be transmitted from the server 30 to the client apparatus 10 after step S131 and before step S212.

As a second example of the acquisition of the third information (S212), the client apparatus 10 acquires, in response to an input from the user, the user's review of a dish the user has made or a dish the user has eaten.

As a third example of the acquisition of the third information (S212), the client apparatus 10 acquires an image of the dish or the user (for example, an image of the user performing a particular gesture) captured while the user is cooking or eating.

As a fourth example of the acquisition of the third information (S212), the client apparatus 10 acquires a sound (sound signal) received by a microphone while the user is cooking or eating (e.g., a sound produced by the user uttering a particular keyword).

The fifth example of the acquisition of the third information (S212) is a combination of two or more of the above first to fourth examples.

Note that the acquisition of the third information (S212) may be triggered by detection of a particular speech or gesture by the user.

After step S212, the client apparatus 10 executes output of the third information (S213).

Specifically, the client apparatus 10 transmits the third information acquired in step S212 to the server 30.

After step S213, the server 30 executes the acquisition of the third information (S232).

Specifically, the server 30 receives the third information transmitted in step S213. Further, the server 30 may extract user information (in particular, attribute information) stored in the user database (FIG. 6) as the third information, may extract review information (review information posted by the same user in the past) stored in the review database (FIG. 7) as the third information, or may extract recipe information (recipe information posted by the same user in the past) stored in the recipe database (not shown) as the third information.

After step S232, the server 30 executes selection of a question (S233).

Specifically, the server 30 refers to the knowledge database (FIG. 10) and selects at least one of the questions associated with the target dish identified in step S131 based on the third information acquired in step S232.

As a first example of the selection of a question (S233), the server 30 selects a question designated by the user.

As a second example of the selection of a question (S233), the server 30 selects a question based on the result of analyzing the user's review of the dish made by the user or the dish eaten by the user. As an example, the server 30 may select a question that best matches the user's review with respect to meaning or expression. Note that the analysis of the review may be performed by the server 30, the client apparatus 10, or an external apparatus.

As a third example of the selection of a question (S233), the server 30 selects a question based on the result of analyzing an image or sound collected while the user is cooking or eating. For example, the image reflects the shape or color of the food, or the behavior of the user (e.g., the time it takes to perform a particular cooking process, or the magnitude of movement). In addition, the sound reflects a sound made by ingredients during the cooking process (e.g., a sound made when ingredients are heated), the hardness, moisture content, or the like of the food. As an example, the server 30 may select a question that the cook is likely to have when a similar feature is observed by applying a trained model that infers a question to a feature based on the image or sound. Such a model can be constructed by supervised learning using training data including a large number of sample features (image or sound features collected during cooking or eating of a particular dish) and correct data (a result of having the cook of the dish select a question about the dish). Note that the analysis of the image or sound (e.g., extraction of a feature) may be performed by the server 30, the client apparatus 10, or an external apparatus.

As a fourth example of the selection of a question (S233), the server 30 selects a question based on user information or a group of reviews or recipes posted by the user. For example, even in the case of the same dish, users with limited experience in cooking similar dishes may have different questions than users with moderate experience in cooking similar dishes. As an example, the server 30 may select a question for which the cook is not likely to know the answer when a similar feature is observed by applying a trained model that infers a question to a feature based on these types of information. Such a model can be constructed by supervised learning using training data including a large number of sample features (features of attributes or cooking histories of cooks who created a particular dish) and correct data (results of having the cooks select a question about the dish). The extraction of the feature may be performed by the server 30, the client apparatus 10, or an external apparatus.

As a fifth example of the selection of a question (S233), the server 30 determines a cooking process when the user uttered a particular keyword or performed a particular gesture, for example, based on a result of analyzing an image or sound collected while the user was cooking, and selects a question associated with the target dish and cooking process information corresponding to the determined cooking process.

After step S233, the server 30 executes output of knowledge (S234).

Specifically, the server 30 refers to the knowledge database (FIG. 10) and acquires the knowledge associated with the question selected in step S233. The server 30 transmits the acquired knowledge to the client apparatus 10.

After step S234, the client apparatus 10 executes presentation of the knowledge (S214).

Specifically, the client apparatus 10 receives the knowledge transmitted in step S234, and presents it to the user. For example, the client apparatus 10 displays the knowledge (text or image) on the display 21 or outputs the knowledge (voice) from a speaker. Alternatively, the client apparatus 10 may provide recipe information to which the knowledge has been added to the user.

### (6-1-3) Summary

As described above, the server 30 of the first modification stores a dish, a question about the dish, and knowledge about the answer to the question in association with each other. The server 30 identifies a target dish of interest to the user, selects at least one question associated with the target dish, and outputs knowledge associated with the selected question. As a result, the user can resolve the question based on the presented knowledge, making it easier for the user to acquire appropriate cooking behavior and a mindset. As described above, cooking instruction suitable for the user can be provided.

The server 30 may receive a voice or gesture from a user during cooking or eating of a target dish and select at least one question associated with the target dish based on the result of analyzing the voice or gesture. Thus, when the user has a question during cooking, the user can receive necessary knowledge by speaking or gesturing.

### (7) Other Modifications

The storage device 11 may be connected to the client apparatus 10 via the network NW. The display 21 may be built in the client apparatus 10. The storage device 31 may be connected to the server 30 via the network NW.

Each step of the above-described information processing can be executed by either the client apparatus 10 or the server 30. Further, an example is shown in which the information processing system of the embodiment is implemented by a client/server type system. However, the information processing system of the embodiment may also be implemented by a stand-alone computer or a peer-to-peer system.

In the above-described embodiment or modifications, a failure type of the target dish experienced by the user or a question that the user has about the target dish is estimated and knowledge is provided. However, for example, the server 30 may ask a quiz about any of the knowledge associated with the target dish to the user via the client apparatus 10 and receive an answer. Then, the server 30 may select a failure type or question based on the result of the user's answer to the quiz. As an example, the server 30 presents, to the user via the client apparatus 10, knowledge about a quiz that the user answered incorrectly. As a result, it is possible to increase the opportunities for the user to receive knowledge that the user does not yet know or does not correctly understand, thereby further contributing to the improvement of the cooking skills and knowledge of the user. Note that, in the present modification, the target dish may be randomly selected regardless of the user's experience of cooking or eating or intention.

In addition to the information described in the above embodiment, information on failure types selected in the past for a user can be accumulated and used as the second information. Similarly, in addition to the information described in the first modification, information on questions selected for a user in the past can be accumulated and used as the third information.

In the above-described embodiment, a failure type is selected based on the second information. However, the server 30 may select a failure type at random, or may define the frequency of occurrence for each failure type associated with a dish in the knowledge database (FIG. 5), and select failure types in the order of the high frequency of occurrence or select a failure type with a probability corresponding to the frequency of occurrence. Similarly, in the first modification, a question is selected based on the third information. However, the server 30 may select a question at random, or may define the frequency of occurrence for each question associated with the dish in the knowledge database (FIG. 10), and select questions in the order of the high frequency of occurrence or select a question with a probability corresponding to the frequency of occurrence.

In the embodiment described above, the first information is acquired separately from the second information, and a target dish is identified. However, the first information and the second information may be the same information, and in this case, the server 30 may successively execute the identification of a target dish (S131) and the selection of a failure type (S133). Similarly, in the first modification, the first information is acquired separately from the third information, and a target dish is identified. However, the first information and the third information may be the same information, and in this case, the server 30 may successively execute the identification of a target dish (S131) and the selection of a question (S233).

When selecting a failure type or question, the server 30 may identify the relevant cooking process to narrow down the candidates to the failure types or questions associated with the cooking process of the target dish. For example, the server 30 may identify the cooking process based on at least one of the following information:
User's self-report (designation of the relevant cooking process);
Result of analyzing user's review;
Result of analyzing at least one of an images or sound collected during cooking or eating of the target dish;
Operating information on a cooking utensil, a cooking equipment, or other kitchen appliances; and
Elapsed time from the start of cooking to the point in time when the second or third information is obtained.

In the above-described embodiment or modifications, knowledge on a failure type or a question related to a target dish is provided. However, for example, knowledge useful for making a target dish having a feature desired by a user can be provided by using a knowledge database in which a dish, a feature of the dish (directivity of seasoning, texture, arrangement, or the like), and knowledge for cooking the dish having the feature are associated with each other.

The embodiment of the present invention has been described in detail above, but the scope of the present invention is not limited to the above-described embodiment. In addition, the above-described embodiment can be improved or modified in various ways without departing from the gist of the present invention. In addition, the above-described embodiment and modifications may be combined.

What is claimed is:

1. An apparatus comprising:
processing circuitry configured to:
store a dish, a failure type of the dish, and knowledge about the failure type of the dish in association with each other;
identify a target dish of interest to a user;
select at least one failure type of the failure type associated with the target dish; and
output the knowledge associated with the selected failure type.

2. The program according to claim 1, wherein
in selecting at least one failure type of the failure type, select a failure type selects at least one failure type of the failure type associated with the target dish in accordance with an instruction by the user.

3. The program according to claim 1,
the processing circuitry further configured to:
acquire a review by the user of a dish made by the user or a dish eaten by the user,
wherein
in selecting at least one failure type of the failure type, select a failure type selects at least one failure type of the failure type associated with the target dish in accordance with a result of analyzing the review.

4. The program according to any one of claims 1, wherein
in selecting at least one failure type of the failure type, select a failure type selects at least one failure type of the failure type associated with the target dish, based on at least one of an attribute of the user or a cooking history of the user.

5. The program according to claim 1,
the processing circuitry further configured to:
acquire at least one of an images or sound collected during cooking or eating of the target dish,
wherein
in selecting at least one failure type of the failure type, select a failure type selects at least one failure type of the failure type associated with the target dish based on a result of analyzing the acquired image or sound.

6. The program according to claim 1,
the processing circuitry further configured to:
ask a quiz about one of the knowledge associated with the target dish; and
receive an answer to the quiz from the user,
wherein
in selecting at least one failure type of the failure type, select a failure type selects the failure type, based on a result of the answer to the quiz from the user.

7. An apparatus comprising:
processing circuitry configured to:
store a dish, a question about the dish, and knowledge about an answer to the question in association with each other;
identify a target dish of interest to a user;
select at least one question of the question associated with the target dish; and
output the knowledge associated with the selected question.

8. The program according to claim 7,
the processing circuitry further configured to:
receive a voice or gesture from the user during cooking or eating of the target dish,
wherein
in selecting at least one question of the question, select a question selects at least one question of the question associated with the target dish based on a result of analyzing the voice or gesture.

9. The program according to claim 7,
the processing circuitry further configured to:
ask a quiz about one of the knowledge associated with the target dish; and
receive an answer to the quiz from the user,
wherein
in selecting at least one question of the question, select a question selects the question, based on a result of the answer to the quiz from the user.

10. A method performed by a computer,
wherein the computer comprises processing circuitry configured to:
store a dish, a failure type of the dish, and knowledge about the failure type of the dish in association with each other;
identify a target dish of interest to a user;
select at least one failure type of the failure type associated with the target dish; and
output the knowledge associated with the selected failure type.

11. A method performed by a computer,
wherein the computer comprises processing circuitry configured to:
store a dish, a question about the dish, and knowledge about an answer to the question in association with each other;
identify a target dish of interest to a user;
select at least one question of the question associated with the target dish; and
output the knowledge associated with the selected question.

12. A system comprising a first information processing apparatus and a second information processing apparatus, wherein
the first information processing apparatus comprises processing circuitry configured to:
store a dish, a failure type of the dish, and knowledge about the failure type of the dish in association with each other;
identify a target dish of interest to a user;
select at least one failure type of the failure type associated with the target dish; and
output the knowledge associated with the selected failure type to the second information processing apparatus.

13. A system comprising a first information processing apparatus and a second information processing apparatus, wherein
the first information processing apparatus comprises processing circuitry configured to:
store a dish, a question about the dish, and knowledge about an answer to the question in association with each other;
identify a target dish of interest to a user;
select at least one question of the question associated with the target dish; and
output the knowledge associated with the selected question to the second information processing apparatus.
